(19) United States
(12) Patent Application Publication
(10) Pub. No.: US 2026/0166810 A1
(43) Pub. Date: Jun. 18, 2026

(54) THREE-DIMENSIONAL PRINTER

(71) Applicant: SHENZHEN CREALITY ECOSYSTEM TECHNOLOGY CO., LTD, Shenzhen City (CN)

(72) Inventors: Dajiang WU, Shenzhen City (CN); Danjun AO, Shenzhen City (CN)

(21) Appl. No.: 19/402,607

(22) Filed: Nov. 26, 2025

(30) Foreign Application Priority Data
Dec. 17, 2024 (CN) 202423133161.6

(51) Int. Cl. B29C 64/241; B29C 64/245; B33Y 30/00

(52) U.S. Cl. CPC B29C 64/241; B29C 64/245; B33Y 30/00

(57) ABSTRACT

A three-dimensional printer includes a printing platform assembly, configured to receive a material extruded by a print head assembly, where the printing platform assembly is provided with a first side and a second side opposite to each other; a first lifting assembly, hinged to the first side; a second lifting assembly, hinged to the second side; a first driving assembly in transmission connection with the first lifting assembly and configured to drive the first lifting assembly to move along a first direction; and a second driving assembly in transmission connection with the second lifting assembly and configured to drive the second lifting assembly to move along the first direction. The first driving assembly and the second driving assembly can respectively drive the first lifting assembly and the second lifting assembly, thereby regulating an included angle between the printing platform assembly and the print head assembly.

### TECHNICAL FIELD

The present disclosure relates to the field of three-dimensional printing, and in particular to a three-dimensional printer.

### BACKGROUND

In fused deposition modeling (FDM), thermoplastic consumables are melted by a heated print head assembly and deposited on a printing platform assembly layer by layer, finally forming a three-dimensional model.

In a related technology, the print head assembly can only print perpendicular to the printing platform assembly. If a model with a certain inclination angle to the printing platform assembly needs to be printed, a support assembly needs to be added on the printing platform assembly, and then the print head assembly can print an inclined model portion on the support assembly, which not only reduces the printing efficiency and increases the printing cost, but also increases the demolding difficulty.

### SUMMARY

An embodiment of the present disclosure provides a three-dimensional printer, which can achieve unsupported printing, is more convenient to use, and can printing efficiency and reduce printing cost and demolding difficulty.

The three-dimensional printer provided by the embodiment of the present disclosure includes:
a printing platform assembly, configured to receive a material extruded by a print head assembly, where the printing platform assembly is provided with a first side and a second side opposite to each other;
a first lifting assembly, hinged to the first side of the printing platform assembly;
a second lifting assembly, hinged to the second side of the printing platform assembly;
a first driving assembly, which is in transmission connection with the first lifting assembly and configured to drive the first lifting assembly to move along a first direction; and
a second driving assembly, which is in transmission connection with the second lifting assembly and configured to drive the second lifting assembly to move along the first direction.

The first driving assembly and the second driving assembly can respectively drive the first lifting assembly and the second lifting assembly, thereby regulating an included angle between the printing platform assembly and the print head assembly.

In some embodiments, the first lifting assembly includes two first lifting portions, and the two first lifting portions are hinged to the printing platform assembly and symmetrically arranged on two ends of the first side of the printing platform assembly.

The first driving assembly is configured to drive the two first lifting portions to move synchronously along the first direction, or the first driving assembly is configured to drive the two first lifting portions to move separately along the first direction.

In some embodiments, the first lifting portion includes a first main body and two first connecting arms connected to the first main body. The two first connecting arms are spaced part in a third direction to form a first mounting groove, and the printing platform assembly includes a first hinge portion hinged into the first mounting groove.

Both sides of the first hinge portion in the third direction each are provided with a first avoidance groove, and the first connecting arm is inserted into a corresponding first avoidance groove.

In some embodiments, the first driving assembly includes two first transmission portions extending along the first direction, and the two first transmission portions are in one-to-one transmission connection with the two first lifting portions.

The first driving assembly further includes one first driving portion which is connected to the two first transmission portions and configured to drive the two first transmission portions to rotate synchronously around the first direction, thereby enabling the two first lifting portions to move synchronously along the first direction. Alternatively, the first driving assembly further includes two first driving portions which are in one-to-one connection with the two first transmission portions and configured to drive corresponding first transmission portions to rotate around the first direction, thereby enabling the two first lifting portions to move along the first direction separately.

In some embodiments, the second lifting assembly includes one second lifting portion, and the second lifting portion is hinged to a middle portion of the second side of the printing platform assembly.

In some embodiments, the second driving assembly includes one second transmission portion and one second driving portion, the second transmission portion extends along the first direction and is in transmission connection with the second lifting portion, the second driving portion is connected to the second transmission portion, and the second driving portion is configured to drive the second transmission portion to rotate around the first direction, thereby enabling the second lifting portion to move along the first direction.

In some embodiments, the second lifting assembly includes two second lifting portions, and the two second lifting portions are hinged to the printing platform assembly and symmetrically arranged on two ends of the second side of the printing platform assembly.

The second driving assembly is configured to drive the two second lifting portions to move synchronously along the first direction, or the second driving assembly is configured to drive the two second lifting portions to move separately along the first direction.

In some embodiments, the second driving assembly includes two second transmission portions extending along the first direction, and the two second transmission portions are in one-to-one transmission connection with the two second lifting portions.

The second driving assembly further includes one second driving portion which is connected to the two second transmission portions and configured to drive the two second transmission portions to rotate synchronously around the first direction, thereby enabling the two second lifting portions to move synchronously along the first direction. Alternatively, the second driving assembly further includes two second driving portions which are in one-to-one connection with the two second transmission portions and configured to drive corresponding second transmission portions to rotate around the first direction, thereby enabling the two second lifting portions to move along the first direction separately.

In some embodiments, the second lifting portion includes a second main body and two second connecting arms connected to the second main body. The two second connecting arms are spaced part in the third direction to form a second mounting groove, and the printing platform assembly includes a second hinge portion hinged into the second mounting groove.

Both sides of the second hinge portion in the third direction each are provided with a second avoidance groove, and the second connecting arm is inserted into a corresponding second avoidance groove.

In some embodiments, the printing platform assembly includes:
a base portion, hinged to the first lifting assembly and the second lifting assembly separately;
a printing plane portion, configured to receive the material, where the printing panel portion is rotatably connected to the base portion; and
a third driving portion, configured to drive the printing panel portion to rotate around a central axis of the printing panel portion.

In some embodiments, the printing panel portion includes a platform plate body and a medium layer covering a surface of the platform plate body, where the medium layer is configured to receive the material.

The base portion includes a heat-conducting plate body, a heating body and a seat body arranged in turn along the first direction, where the heat-conducting plate body is attached to the platform plate body, and the seat body is hinged to the first lifting assembly and the second lifting assembly.

In some embodiments, the printing platform assembly includes a printing panel portion. The printing panel portion is provided with a printing surface for receiving the material, an included angle is formed between a normal direction of the printing surface and an extrusion direction of the print head assembly, which ranges from 0° to 60°.

In some embodiments, the three-dimensional printer further includes a motion assembly and a frame assembly.

The motion assembly is configured to drive the print head assembly to move along a second direction and/or a third direction, where the first direction, the second direction and the third direction are mutually perpendicular.

The frame assembly includes a first frame portion extending along the first direction, a second frame portion extending along the second direction, a third frame portion extending along the third direction, and a connecting portion for connecting the first frame portion, the second frame portion and the third frame portion.

The motion assembly is mounted on the connecting portion.

In some embodiments, the connecting portion includes a body and a mounting support which are integrally formed.

The body is provided with an outer side and an inner side opposite to each other.

The mounting support is formed on the inner side of the body and used for mounting the motion assembly.

The first frame portion, the second frame portion and the third frame portion are detachably connected to the outer side of the body separately.

Compared with the prior art, the embodiment of the present disclosure has beneficial effects as follows. The three-dimensional printer includes a printing platform assembly, configured to receive a material extruded by a print head assembly, where the printing platform assembly is provided with a first side and a second side opposite to each other; a first lifting assembly, hinged to the first side of the printing platform assembly; a second lifting assembly, hinged to the second side of the printing platform assembly; a first driving assembly, which is in transmission connection with the first lifting assembly and configured to drive the first lifting assembly to move along a first direction; and a second driving assembly, which is in transmission connection with the second lifting assembly and configured to drive the second lifting assembly to move along the first direction. Through the embodiments of the present disclosure, the first driving assembly and the second driving assembly can respectively drive the first lifting assembly and the second lifting assembly, so that the first lifting assembly and the second lifting assembly have a height difference in a first direction, that is, the first side and the second side of the printing platform assembly have a height difference in the first direction, so that the printing platform assembly is obliquely arranged relative to the print head assembly to achieve unsupported printing. An included angle between the printing platform assembly and the print head assembly can be regulated through the first driving assembly and the second driving assembly, so that the use is more convenient, the printing efficiency is improved, and the printing cost and the demolding difficulty are reduced.

### BRIEF DESCRIPTION OF THE DRAWINGS

FIG. 1 is a structural diagram of a three-dimensional printer according to an embodiment of the present disclosure;

FIG. 2 is a diagram of a three-dimensional printer shown in FIG. 1 from another perspective;

FIG. 3 is a diagram of a partial structure of a three-dimensional printer shown in FIG. 1;

FIG. 4 is a diagram of a three-dimensional printer shown in FIG. 3 from another perspective;

FIG. 5 is a sectional diagram of a three-dimensional printer shown in FIG. 3;

FIG. 6 is a diagram of a partial structure of three-dimensional printer according to an embodiment of the present disclosure;

FIG. 7 is a diagram of a partial structure of a three-dimensional printer shown in FIG. 1;

FIG. 8 is a diagram of a partial structure of a three-dimensional printer shown in FIG. 7;

FIG. 9 is a structural diagram of a connecting portion in a three-dimensional printer shown in FIG. 8;

FIG. 10 is a diagram of a connecting portion shown in FIG. 9 from another perspective.

1—printing platform assembly (101—first side, 102—second side, 103—base portion (1031-heat-conducting plate body, 1032—heating body, 1033—seat body), 104—printing panel portion (1041—medium layer, 1042—platform plate body, 1043—printing surface), 105—third driving portion, 106—first hinge portion (1061—first avoidance groove), 107—second hinge portion (1071—second avoidance groove)), 2—first lifting assembly (201—first lifting portion (2011—first main body, 2012—first connecting arm, 2013—first mounting groove)), 3—second lifting assembly (301—second lifting portion (3011—second main body, 3012—second connecting arm, 3013—second mounting groove)), 4—first driving assembly (401—first transmission portion), 5—second driving assembly (501—second transmission portion), 6—print head assembly, 7—first rotating shaft; 8—first guide assembly (801—first guide portion), 9—second rotating shaft, 10—second guide assembly (1001—second guide portion), 11—motion assembly (1101—belt, 1102—idle pulley), 12—frame assembly (1201—first frame portion, 1201—second frame portion, 1203—third frame portion, 1204—connecting portion (12041—body (120411-outer side, 120412—inner side), 12042—mounting support).

### DETAILED DESCRIPTION OF THE EMBODIMENTS

To facilitate the understanding of the present disclosure, the present disclosure will be described more comprehensively below with reference to relevant accompanying drawings. Preferred embodiments of the present disclosure are shown in the accompany drawings. However, the present disclosure can be implemented in many different forms and is not limited to the embodiments described herein. On the contrary, these embodiments are provided to make the disclosure of the present disclosure more thorough and comprehensive.

It should be noted that when an element is said to be “fixed” to another element, it may be directly on another element or there may be an intervening element. When an element is said to be “connected” to another element, it may be directly connected to another element or there may be an intervening element.

Unless otherwise defined, all technical and scientific terms used herein have the same meaning as commonly understood by those skilled in the art. The terminology used in the specification of the present disclosure is only for the purpose of describing specific embodiments rather than limiting the present disclosure.

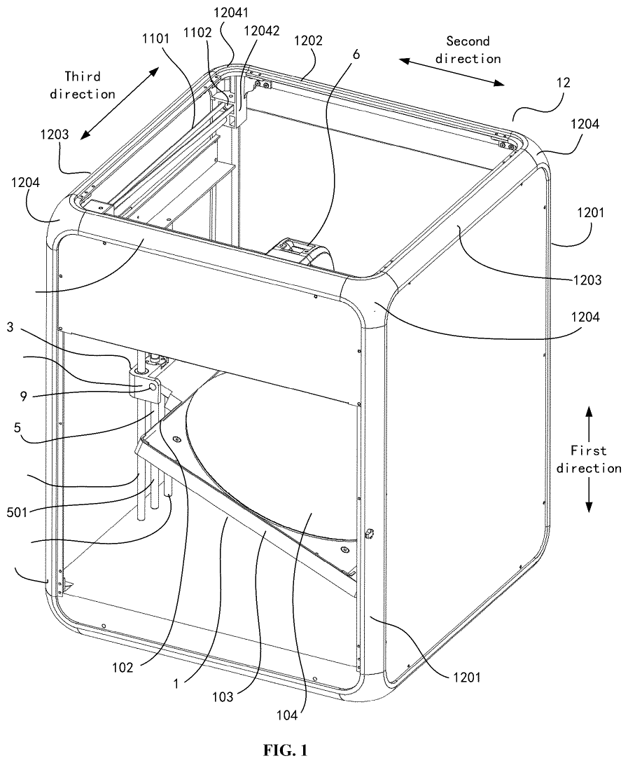

With reference to FIG. 1 to FIG. 6, a three-dimensional printer provided by an embodiment of the present disclosure includes a printing platform assembly 1, a first lifting assembly 2, a second lifting assembly 3, a first driving assembly 4, and a second driving assembly 5. The printing platform assembly 1 is configured to receive a material extruded by a print head assembly 6, where the printing platform assembly 1 is provided with a first side 101 and a second side 102 opposite to each other. The first lifting assembly 2 is hinged to the first side 101 of the printing platform assembly 1. The second lifting assembly 3 is hinged to the second side 102 of the printing platform assembly 1. The first driving assembly 4 is in transmission connection with the first lifting assembly 2, and configured to drive the first lifting assembly 2 to move along a first direction. The second driving assembly 5 is in transmission connection with the second lifting assembly 2, and configured to drive the second lifting assembly 3 to move along the first direction. The first driving assembly 4 and the second driving assembly 5 can respectively drive the first lifting assembly 2 and the second lifting assembly 3 to move, thereby regulating an included angle a between the printing platform assembly 1 and the print head assembly 6.

According to the embodiment of the present disclosure, the first driving assembly 4 and the second driving assembly 5 can respectively drive the first lifting assembly 2 and the second lifting assembly 3, making the first lifting assembly 2 and the second lifting assembly 3 have a height difference in the first direction. That is, the first side 101 and the second side 102 of the printing platform assembly 1 have a height difference in the first direction, so that the printing platform assembly 1 is arranged obliquely relative to the print head assembly 6, the print head assembly 6 can directly print a model with a certain inclination angle with the printing platform assembly 1 on the printing platform assembly 1 to achieve unsupported printing. The included angle a between the printing platform assembly 1 and the print head assembly 6 can be adjusted through the first driving assembly 4 and the second driving assembly 5, so that the use is more convenient, the printing efficiency is improved, and the printing cost and the demolding difficulty are reduced.

As an example, the print head assembly 6 may extrude the material along the first direction, where the first direction is a vertical direction, namely, a Z direction. The first driving assembly 4 and the second driving assembly 5 can respectively drive the first lifting assembly 2 and the second lifting assembly 3 to make the first lifting assembly 2 and the second lifting driving assembly located at a same height, so that the first side 101 and the second side 102 of the printing platform assembly 1 are located at the same height, and the printing platform assembly is parallel to a horizontal plane, that is, the printing platform assembly 1 is perpendicular to the first direction. With reference to FIG. 1 to FIG. 4, the first driving assembly 4 and the second driving assembly 5 can respectively drive the first lifting assembly 2 and the second lifting assembly 3 to make the first lifting assembly 2 and the second lifting driving assembly located at different heights, so that the first side 101 and the second side 102 of the printing platform assembly 1 are located at different heights, and the printing platform assembly 1 is arranged obliquely relative to the horizontal plane. The included angle a between the printing platform assembly 1 and the print head assembly 6 can be adjusted through the first driving assembly 4 and the second driving assembly 5 according to actual situations.

It should be noted that in other embodiments, the print head assembly 6 may extrude the material along other directions, which may be set according to actual situations and thus will not be described in detail here.

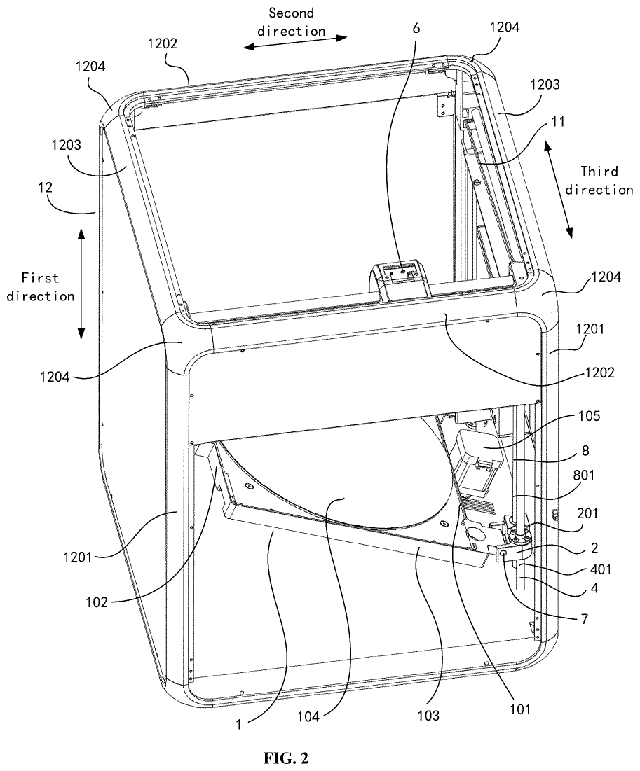

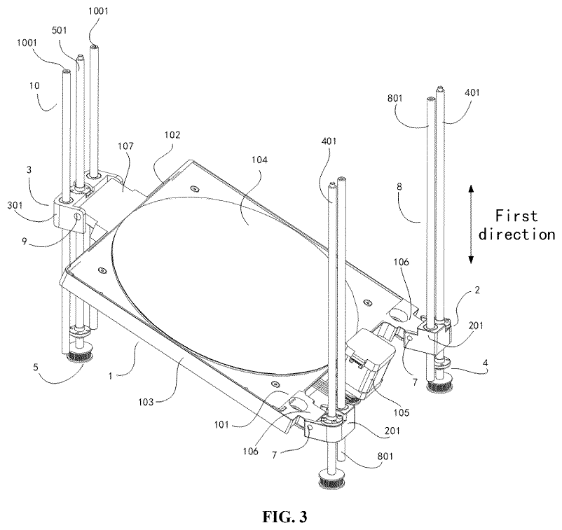

In some embodiments, with reference to FIG. 2, FIG. 3 and FIG. 6, the first lifting assembly 2 includes two first lifting portions 201, the two first lifting portions 201 are hinged to the first side 101 of the printing platform assembly 1, and the two lifting portions 201 are symmetrically arranged on two ends of the first side 101 of the printing platform assembly 1. The first driving assembly 4 is configured to drive the two first lifting portions 201 to move synchronously along the first direction, that is, the two ends of the first side 101 of the printing platform assembly 1 are always located at a same height. Alternatively, the first driving assembly 4 is configured to drive the two first lifting portions 201 to move along the first direction, that is, the two ends of the first side 101 of the printing platform assembly 1 may be located at different heights, further increasing an inclination angle regulation range of the printing platform assembly 1.

As an embodiment, with reference to FIG. 5 and FIG. 6, the first lifting portion 201 includes a first main body 2011 and two first connecting arms 2012. The two first connecting arms 2012 are connected to the first main body 2011, and the two first connecting arms 2012 are spaced apart in a third direction to form a first mounting groove 2013. The printing platform assembly 1 includes a first hinge portion 106 hinged into the first mounting groove 2013, thereby effectively improving connection stability, and preventing the printing platform assembly 1 and the first lifting portion 201 from moving relatively.

As an example, with reference to FIG. 5 and FIG. 6, the first hinge portion 106 may be provided with two first avoidance grooves 1061, and the two first avoidance grooves 1061 are arranged on both sides of the first hinge portion 106 in the third direction, and the first avoidance grooves 1061 are in one-to-one correspondence with the first connecting arms 2012. The first connecting arm 2012 is inserted into a corresponding first avoidance groove 1061, and a first rotating shaft 7 penetrates into the two first connecting arms 2012 and the first hinge portion 106 along the third direction.

As an embodiment, with reference to FIG. 2, FIG. 3 and FIG. 6, the first driving assembly 4 includes two first transmission portions 401, the two first transmission portions 401 are parallel and spaced apart, and the two first transmission portions 401 extend separately along the first direction. The first transmission portions 401 and the first lifting portions 201 are in one-to-one correspondence, where one of the first transmission portions 401 is in transmission connection with one of the first lifting portions 201, and the other first transmission portion 401 is in transmission connection with the other first lifting portion 201. As an example, the first transmission portion 401 may be a lead screw, and the first lifting portion 201 may include a lead screw nut. When the first transmission portion 401 rotates around its own axis, the corresponding first lifting portion 201 moves vertically along the first direction.

In some examples, the first driving assembly 4 may include one first driving portion (not shown in the figure), the first driving portion is connected to the two first transmission portions 401, the printing platform assembly 1 can rotate around the first rotating shaft 7 parallel to the first side 101 relative to the first lifting portion 201. When the first driving portion operates, the first driving portion can drive the two first driving portions 401 to rotate synchronously around the first direction, so that the two first lifting portions 201 can move synchronously along the first direction, and two ends of the first side 101 of the printing platform assembly 1 are always located at a same height.

In some other examples, the first driving assembly 4 may include two first driving portions, and the two first driving portions are in one-to-one correspondence with the two first transmission portions 401. One of the first driving portions is connected to one of the first driving portions 401, and the other first driving portion is connected to the other first transmission portion. The two first driving portions are configured to drive corresponding first transmission portions 401 to rotate around the first direction to make the two first lifting portions 201 move along the first direction, so that the two ends of the first side 101 of the printing platform assembly 1 may or may not be located at the same height, which can be set according to actual situations, and thus will not be repeated in detail here. As an example, the first lifting portion 201 may be connected to the printing platform assembly 1 by a universal hinge joint, where the universal hinge joint is the prior art, and thus will not be described in detail here.

As an example, the first driving portion may be a motor.

In some embodiments, with reference to FIG. 2, FIG. 3 and FIG. 6, the three-dimensional printer may further include a first guide assembly 8. The first guide assembly 8 may include two first guide portions 801 which are arranged in parallel and spaced apart from each other, the two first guide portions 801 can extend along the first direction, and the two first guide portions 801 are in one-to-one sliding connection with the two first lifting portions 201. The first lifting portion 201 may slide along the corresponding first guide portion 801.

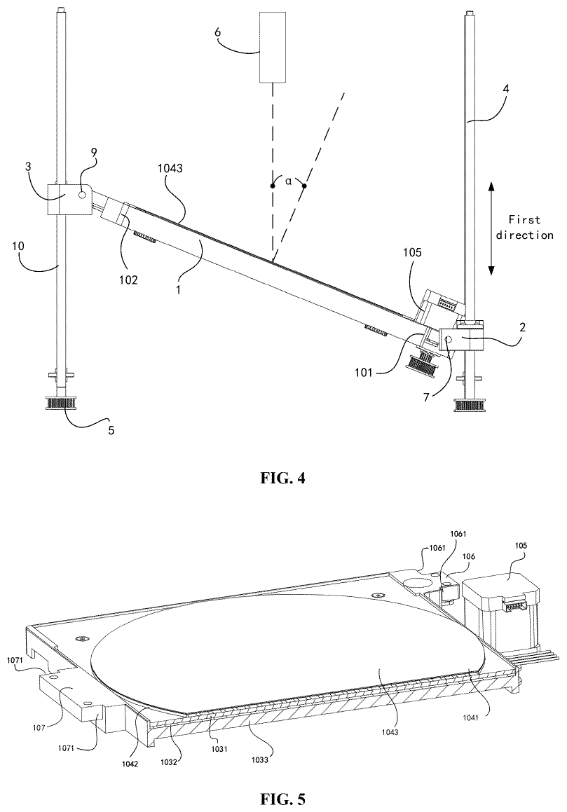

In some embodiments, with reference to FIG. 1, FIG. 3 and FIG. 4, the second lifting assembly 3 includes one second lifting portion 301, and the second lifting portion 301 is hinged to a middle portion of the second side 102 of the printing platform assembly 1. As an example, the printing platform assembly 1 may include two first lifting portions 201 and one second lifting portion 301, which are not only simple in structure, but also can stably support the printing platform assembly 1.

As an embodiment, with reference to FIG. 1, FIG. 3 and FIG. 4, the second driving assembly 5 includes one second transmission portion 501 and one second driving portion (not shown in the figure), the second transmission portion 501 extends along the first direction and is in transmission connection with the second lifting portion 301, the second driving portion is connected to the second transmission portion 501, and the second driving portion is configured to drive the second transmission portion 501 to rotate around the first direction, thereby enabling the second lifting portion 301 to move along the first direction. As an example, the second transmission portion 501 may be a lead screw, the second lifting portion 301 may include a lead screw nut, and the second driving portion may be a motor. When the second driving portion drives the second transmission portion 501 to rotate around an axis of the second transmission portion 501, the second lifting portion 301 moves vertically along the first direction.

As an example, with reference to FIG. 1, FIG. 3 and FIG. 4, the three-dimensional printer may further include a second guide assembly 10. The second guide assembly 10 may include two second guide portions 1001 which are arranged in parallel and spaced apart from each other, the two second guide portions 1001 extends separately along the first direction, and the two second guide portions 1001 are in sliding connection with the second lifting portion 301. The second lifting portion 301 may slide along the two second guide portions 1001. The second transmission portion 501 is arranged between the two second guide portions 1001.

In some embodiments, with reference to FIG. 6, the second lifting assembly 3 includes two second lifting portions 301, the two second lifting portions 301 are hinged to the second side 102 of the printing platform assembly 1, and the two second lifting portions 301 are symmetrically arranged on two ends of the second side 102 of the printing platform assembly 1. As an example, the printing platform assembly 1 may include two first lifting portions 201 and two second lifting portions 301, which can stably support the printing platform assembly 1 and adjust an inclination angle of the printing platform assembly 1 more accurately. The second driving assembly 5 is configured to drive the two second lifting portions 301 to move synchronously along the first direction, that is, the two ends of the second side 102 of the printing platform assembly 1 are always located at a same height. Alternatively, the second driving assembly 5 is configured to drive the two second lifting portions 201 to move along the first direction, that is, the two ends of the second side 102 of the printing platform assembly 1 may be located at different heights, further increasing an inclination angle regulation angle of the printing platform assembly 1.

As an embodiment, with reference to FIG. 6, the second driving assembly 5 includes two second transmission portions 501, the two second transmission portions 501 are parallel and spaced apart from each other, and the two second transmission portions 501 extend separately along the first direction. The second transmission portions 501 and the second lifting portions 301 are in one-to-one correspondence, where the second transmission portion 501 is in transmission connection with one of the second lifting portions 301, and the other second transmission portion 501 is in transmission connection with the other second lifting portion 301. As an example, the second transmission portion 501 may be a lead screw, and the second lifting portion 301 may include a lead screw nut. When the second transmission portion 501 rotates around its own axis, the corresponding second lifting portion 301 moves vertically along the first direction.

In some examples, the second driving assembly 5 may include one second driving portion, the second driving portion is connected to the two second transmission portions 501 separately, and the printing platform assembly 1 may rotate around a second rotating shaft 9 parallel to the second side 102 relative to the second lifting portion 301. When the second driving portion operates, the second driving portion may drive the two second driving portions 501 to rotate synchronously around the first direction, so that the two second lifting portions 301 can move synchronously along the first direction, and two ends of the second side 102 of the printing platform assembly 1 are always located at a same height.

In some other examples, the second driving assembly 5 may include two second driving portions, and the two second driving portions are in one-to-one correspondence with the two second transmission portions 501. One of the second driving portions is connected to one of the second driving portions 501, and the other second driving portion is connected to the other second transmission portion. The two second driving portions are configured to respectively drive the corresponding second transmission portions 501 to rotate around the first direction, so that the two second lifting portions 301 can move separately along the first direction, the two ends of the second side 102 of the printing platform assembly 1 may or may not be located at the same height, which can be set according to actual situations, and thus will not be repeated in detail here. As an example, the second lifting portion 301 may be connected to the printing platform assembly 1 by a universal hinge joint. The universal hinge joint is the prior art, and thus will not be described in detail here.

As an example, the second driving portion may be a motor.

As an example, with reference to FIG. 6, the three-dimensional printer may further include a second guide assembly 10. The second guide assembly 10 may include two second guide portions 1001 which are arranged in parallel and spaced apart from each other, the two second guide portions 1001 can extend respectively along the first direction, and the two second guide portions 1001 are in one-to-one sliding connection with the second lifting portions 301. The second lifting portion 301 can slide along the corresponding second guide portion 1001.

As an embodiment, referring to FIG. 5 and FIG. 6, the second lifting portion 301 includes a second main body 3011 and two second connecting arms 3012. The two second connecting arms 3012 are connected to the second main body 3011, and the two second connecting arms 3012 are spaced apart in a third direction to form a second mounting groove 3013. The printing platform assembly 1 includes a second hinge portion 107 hinged into the second mounting groove 3013, thereby effectively improving connection stability, and preventing the printing platform assembly 1 and the second lifting portion 301 from moving relatively.

As an example, with reference to FIG. 5 and FIG. 6, the second hinge portion 107 may be provided with two second avoidance grooves 1071, and the two second avoidance grooves 1071 are arranged on two sides of the second hinge portion 107 in the third direction, and the second avoidance grooves 1071 are in one-to-one correspondence with the second connecting arms 3012. The second connecting arm 3012 is inserted into a corresponding second avoidance groove 1071, and the second rotating shaft 9 penetrates into the two second connecting arms 3012 and the second hinge portion 107 along the third direction.

In some embodiments, with reference to FIG. 1 to FIG. 6, the printing platform assembly 1 includes a base portion 103, a printing panel portion 104, and a third driving portion 105. A first side 101 of the base portion 103 is hinged to the first lifting assembly 2, and a second side 102 of the base is hinged to the second lifting assembly 3. The printing plane portion 104 is configured to receive the material, where the printing panel portion 104 is rotatably connected to the base portion 103. The third driving portion 105 is configured to drive the printing panel portion 104 to rotate around a central axis of the printing panel portion 104.

In this embodiment, the printing platform assembly 1 can be arranged obliquely relative to the print head assembly 6, and a distance between the printing platform assembly 1 and the print head assembly 6 is adjustable. In addition, the printing panel portion 104 of the printing platform assembly 1 may rotate around a central axis of the printing panel portion 104, which further improves printing accuracy.

As an example, the third driving portion 105 may be a motor.

As an embodiment, with reference to FIG. 5, the printing panel portion 104 includes a medium layer 1041 and a platform plate body 1042 arranged in turn in the first direction. The medium layer 1041 is fixed to a surface of the platform plate body 1042, the medium layer 1041 is configured to receive the material, where the medium layer 1041 can ensure good adhesion between a printing model and the printing panel portion 104, an object can be taken off from the printing panel portion 104 easily after printing, and the platform plate body 1042 is protected from being damaged. The base portion 103 includes a heat-conducting plate body 1031, a heating body 1032 and a seat body 1033 arranged in turn along the first direction. The heat-conducting plate body 1031 is attached to the platform plate body 1042, the heat-conducting plate body 1031 is configured to transfer heat generated by the heating body 1032 to the printing panel portion 104. The seat body 1033 is hinged to the first lifting assembly 2 and the second lifting assembly 3 separately. That is, the first hinge portion 106 and the second hinge portion 107 are arranged on two sides of the seat body 1033 in the third direction.

As an example, the platform plate body 1042 may be made of spring steel, the medium layer 1041 may be made of polyetherimide, the heat-conducting plate body 1031 may be made of aluminum. Alternatively, the platform plate body 1042, the medium layer 1041 and the heat-conducting plate body 1031 may be made of other materials, which can be set according to actual situations, and thus will not be described in detail here.

In some embodiments, with reference to FIG. 4, the printing panel portion 104 has a printing surface 1043 for receiving the material, and an included angle a formed between a normal direction of the printing surface 1043 and an extrusion direction of the print head assembly may range from 0° to 60°, so that a model with a certain inclination angle can be directly printed on the printing platform assembly 1, and unsupported printing can be achieved.

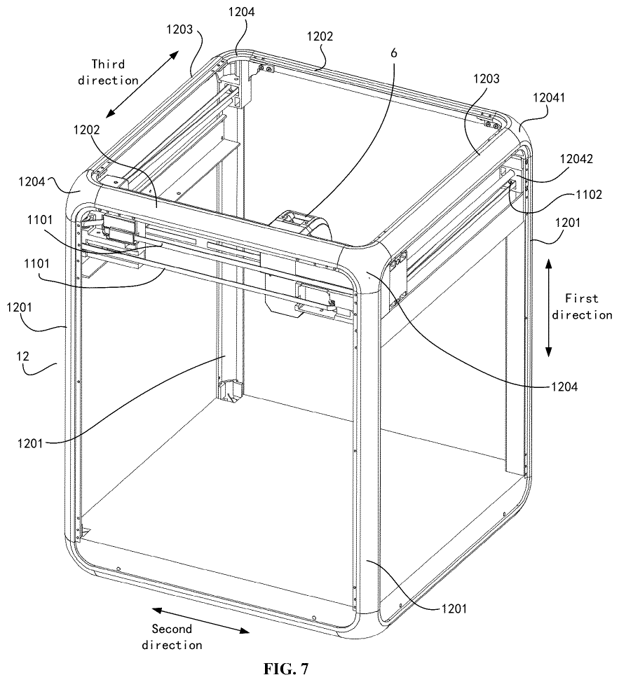

In some embodiments, with reference to FIG. 1, FIG. 2 and FIG. 7, the three-dimensional printer may further include a motion assembly 11. The motion assembly 11 can drive the print head assembly 6 to move along at least one of the second direction and the third direction. The first direction, the second direction and the third direction are mutually perpendicular, thereby further improving the printing accuracy.

As an embodiment, with reference to FIG. 1 and FIG. 2, the first driving assembly 4 and the second driving assembly 5 can respectively drive the first lifting assembly 2 and the second lifting assembly 3 to move to adjust the included angle between the printing platform assembly 1 and the print head assembly 6. The third driving portion 105 can drive the printing panel portion 104 to rotate around a central axis of the printing panel portion 104, and a motion assembly 11 can drive the print head assembly 6 to move along at least one of the second and third directions, thereby flexibly adjusting a relationship and the included angle between the print head assembly 6 and the printing platform assembly 1 and greatly improving the printing accuracy and the printing efficiency.

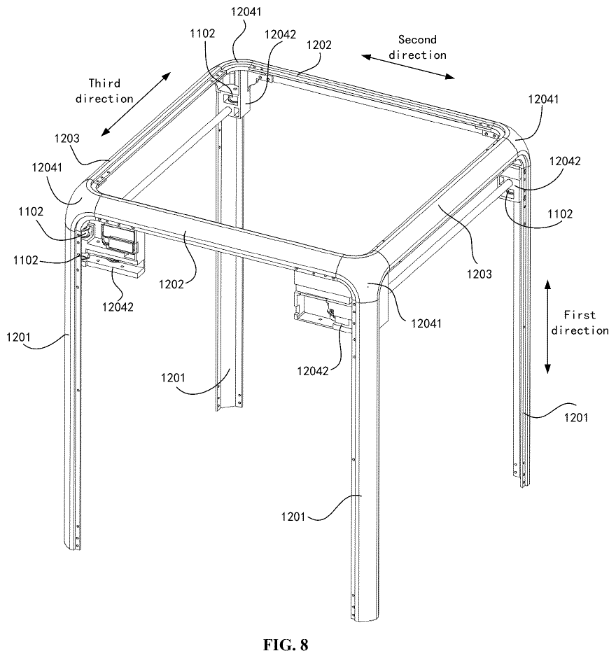

In some embodiments, with reference to FIG. 1, FIG. 2, and FIG. 7 to FIG. 10, the three-dimensional printer may further include a frame assembly 12. The frame assembly 12 includes a first frame portion 1201, a second frame portion 1202, and a third frame portion 1203. The first frame portion 1201 extends along the first direction, the second frame portion 1202 extends along the second direction, and the third frame portion 1203 extends along the third direction. The frame assembly 12 further includes a connecting portion 1204, which is configured to connect the first frame portion 1201, the second frame portion 1202 and the third frame portion 1203 into a whole, and may also be used for mounting the motion assembly 11.

In this embodiment, the connecting portion 1204 is not only a connector of an external frame of the three-dimensional printer, but also an internal functional part for mounting the motion assembly 11, which integrates multiple functions, and is not only simpler in structure and lower in cost, but also more convenient to assemble.

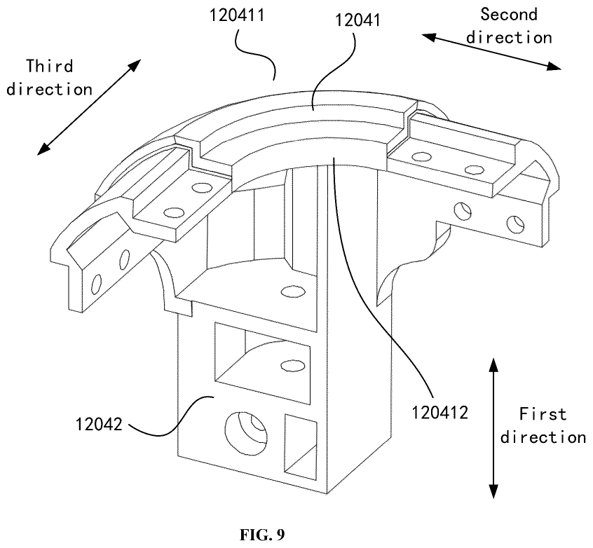

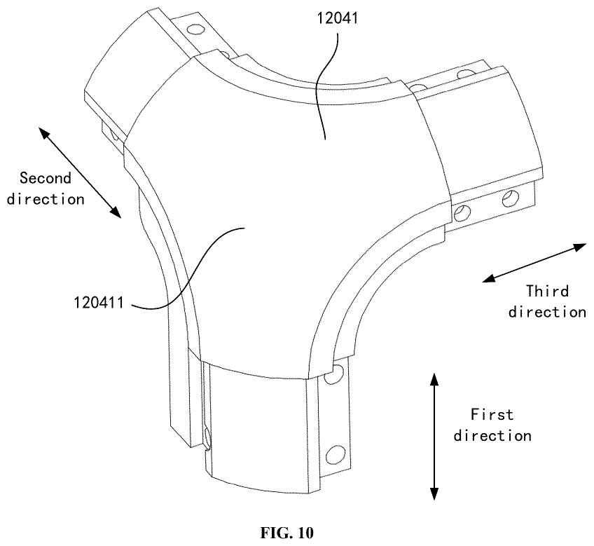

As an embodiment, with reference to FIG. 9 and FIG. 10, the connecting portion 1204 is of an integrated structure, and includes a body 12041 and a mounting support 12042 which are integrally formed. The body 12041 is provided with an outer side 120411 and an inner side 120412 opposite to each other, the mounting support 12042 is formed on the inner side 120412 of the body 12041, and the mounting support 12042 is used for mounting the motion assembly 11. The first frame portion 1201 is detachably connected to the outer side 120411 of the body 12041, the second frame portion 1202 is detachably connected to the outer side 120411 of the body 12041, and the third frame portion 1203 is detachably connected to the outer side of the 120411 of the body 12041.

As an example, the first frame portion 1201, the second frame portion 1202 and the third frame portion 1203 may be connected to the body 12041 by bolts or other fasteners.

As an example, the connecting portion 1204 may be an injection molded part, a die casting part, or other integrally formed parts, which can be set according to actual situations and thus will not be described in detail here.

As an example, the first frame portion 1201, the second frame portion 1202 and the third frame portion 1203 may be profiles, or other structures, which may be set according to actual situations, and thus will not be described in detail here.

As an embodiment, with reference to FIG. 1, FIG. 2 and FIG. 7, the motion assembly 11 includes a belt 1101, a fourth driving portion (not shown in the figure), and an idle pulley 1102.

The belt 1101 is connected to the print head assembly 6. The fourth driving portion is mounted to the connecting portion 1204, and can drive the belt 1101 to move, thereby enabling the print head assembly 6 to move along at least one of the second direction and the third direction. The idle pulley 1102 is mounted to the connecting portion 1204, and is configured to tension the belt 1101.

As an example, the fourth driving portion may be a motor.

It should be noted that the motion assembly 11 in this embodiment may be the prior art, and the mounting of the fourth driving portion and the idle pulley 1103 may be the prior art, and thus will not be described in detail here.

Technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments only describe several embodiments of the present disclosure, and their description is specific and detailed, but cannot be understood as a limitation to the patent scope of the present disclosure. It should be noted that a person of ordinary skill in the art may further make several variations and improvements without departing from the concept of the present disclosure, and these variations and improvements all fall within the scope of protection of the present disclosure. Therefore, the scope of protection of the patent of the present disclosure shall be subject to the appended claims.

1. A three-dimensional printer, comprising:
a printing platform assembly, configured to receive a material extruded by a print head assembly, wherein the printing platform assembly is provided with a first side and a second side opposite to each other;
a first lifting assembly, hinged to the first side of the printing platform assembly;
a second lifting assembly, hinged to the second side of the printing platform assembly;
a first driving assembly, which is in transmission connection with the first lifting assembly and configured to drive the first lifting assembly to move along a first direction; and
a second driving assembly, which is in transmission connection with the second lifting assembly and configured to drive the second lifting assembly to move along the first direction, wherein
the first driving assembly and the second driving assembly are able to respectively drive the first lifting assembly and the second lifting assembly, thereby regulating an included angle between the printing platform assembly and the print head assembly.

2. The three-dimensional printer according to claim 1, wherein the first lifting assembly comprises two first lifting portions, the two first lifting portions are hinged to the printing platform assembly and symmetrically arranged on two ends of the first side of the printing platform assembly; and
the first driving assembly is configured to drive the two first lifting portions to move synchronously along the first direction, or the first driving assembly is configured to drive the two first lifting portions to move separately along the first direction.

3. The three-dimensional printer according to claim 2, wherein the first lifting portion comprises a first main body and two first connecting arms connected to the first main body, the two first connecting arms are spaced part in a third direction to form a first mounting groove, and the printing platform assembly comprises a first hinge portion hinged into the first mounting groove;
both sides of the first hinge portion in the third direction each are provided with a first avoidance groove, and the first connecting arm is inserted into a corresponding first avoidance groove.

4. The three-dimensional printer according to claim 2, wherein the first driving assembly comprises two first transmission portions extending along the first direction, and the two first transmission portions are in one-to-one transmission connection with the two first lifting portions;
the first driving assembly further comprises one first driving portion which is connected to the two first transmission portions and configured to drive the two first transmission portions to rotate synchronously around the first direction, thereby enabling the two first lifting portions to move synchronously along the first direction; or the first driving assembly further comprises two first driving portions which are in one-to-one connection with the two first transmission portions and configured to drive corresponding first transmission portions to rotate around the first direction, thereby enabling the two first lifting portions to move along the first direction separately.

5. The three-dimensional printer according to claim 2, wherein the second lifting assembly comprises one second lifting portion, and the second lifting portion is hinged to a middle portion of the second side of the printing platform assembly.

6. The three-dimensional printer according to claim 5, wherein the second driving assembly comprises one second transmission portion and one second driving portion, the second transmission portion extends along the first direction and is in transmission connection with the second lifting portion, the second driving portion is connected to the second transmission portion, and the second driving portion is configured to drive the second transmission portion to rotate around the first direction, thereby enabling the second lifting portion to move along the first direction.

7. The three-dimensional printer according to claim 2, wherein the second lifting assembly comprises two second lifting portions, and the two second lifting portions are hinged to the printing platform assembly and symmetrically arranged on two ends of the second side of the printing platform assembly; and
the second driving assembly is configured to drive the two second lifting portions to move synchronously along the first direction, or the second driving assembly is configured to drive the two second lifting portions to move separately along the first direction.

8. The three-dimensional printer according to claim 7, wherein the second driving assembly comprises two second transmission portions extending along the first direction, and the two second transmission portions are in one-to-one transmission connection with the two second lifting portions; and
the second driving assembly further comprises one second driving portion which is connected to the two second transmission portions and configured to drive the two second transmission portions to rotate synchronously around the first direction, thereby enabling the two second lifting portions to move synchronously along the first direction; or the second driving assembly further comprises two second driving portions which are in one-to-one connection with the two second transmission portions and configured to drive corresponding second transmission portions to rotate around the first direction, thereby enabling the two second lifting portions to move along the first direction separately.

9. The three-dimensional printer according to claim 5, wherein the second lifting portion comprises a second main body and two second connecting arms connected to the second main body, the two second connecting arms are spaced part in the third direction to form a second mounting groove, and the printing platform assembly comprises a second hinge portion hinged into the second mounting groove;
both sides of the second hinge portion in the third direction each are provided with a second avoidance groove, and the second connecting arm is inserted into a corresponding second avoidance groove.

10. The three-dimensional printer according to claim 1, wherein the printing platform assembly comprises:
a base portion, hinged to the first lifting assembly and the second lifting assembly separately;
a printing plane portion, configured to receive the material, wherein the printing panel portion is rotatably connected to the base portion; and
a third driving portion, configured to drive the printing panel portion to rotate around a central axis of the printing panel portion.

11. The three-dimensional printer according to claim 10, wherein the printing panel portion comprises a platform plate body and a medium layer covering a surface of the platform plate body, wherein the medium layer is configured to receive the material;
the base portion comprises a heat-conducting plate body, a heating body and a seat body arranged in turn along the first direction, wherein the heat-conducting plate body is attached to the platform plate body, and the seat body is hinged to the first lifting assembly and the second lifting assembly.

12. The three-dimensional printer according to claim 1, wherein the printing platform assembly comprises a printing panel portion, the printing panel portion is provided with a printing surface for receiving the material, an included angle is formed between a normal direction of the printing surface and an extrusion direction of the print head assembly, which ranges from 0° to 60°.

13. The three-dimensional printer according to claim 1, further comprising a motion assembly and a frame assembly, wherein
the motion assembly is configured to drive the print head assembly to move along a second direction and/or a third direction, wherein the first direction, the second direction and the third direction are mutually perpendicular;
the frame assembly comprises a first frame portion extending along the first direction, a second frame portion extending along the second direction, a third frame portion extending along the third direction, and a connecting portion for connecting the first frame portion, the second frame portion and the third frame portion; and
the motion assembly is mounted on the connecting portion.

14. The three-dimensional printer according to claim 13, wherein the connecting portion comprises a body and a mounting support which are integrally formed;
the body is provided with an outer side and an inner side opposite to each other;
the mounting support is formed on the inner side of the body and used for mounting the motion assembly; and
the first frame portion, the second frame portion and the third frame portion are detachably connected to the outer side of the body separately.
